(19) United States
(12) Patent Application Publication
(10) Pub. No.: US 2011/0314035 A1
(43) Pub. Date: Dec. 22, 2011

(54) Creation, Transfer and Use of a Portable Data Map Using Metadata

(75) Inventors: Jeffrey Brunet, Richmond Hill (CA); Yousuf Chowdhary, Maple (CA); Ian Collins, Markham (CA)

(73) Assignee: Storage Appliance Corporation, Richmond Hill (CA)

(21) Appl. No.: 13/164,400

(22) Filed: Jun. 20, 2011

Related U.S. Application Data
(60) Provisional application No. 61/398,032, filed on Jun. 21, 2010.

(51) Int. Cl. G06F 17/30; G06F 15/16

(52) U.S. Cl. 707/756; 709/206; 707/E17.005

(57) ABSTRACT

A portable data map of a data source is created using metadata obtained from the data source. The created data map represents the entire data set of the data source and can be carried on a mobile device without having to carry the entire data set and thus requiring much less storage space. A user of the mobile device can navigate this data map and view the file/folder hierarchy of the data source even when the mobile device is off line or not currently in communication with the data source. Once a user has made a selection the actual file(s) can be downloaded to the mobile device.

### CROSS-REFERENCE TO RELATED APPLICATIONS

This application claims the benefit of U.S. Provisional Patent Application No. 61/398,032 filed on Jun. 21, 2010 and entitled “Methods and Systems for Creating a Portable Data Map using Metadata,” which is incorporated herein by reference in its entirety.

### BACKGROUND OF THE INVENTION

1. Field of the Invention

The present invention relates generally to remote access to a data repository.

2. Description of the Prior Art

Having access to the data files stored on a data source such as a personal computer when one is physically away from the data source is becoming an essential requirement for many. The sheer size of data stored on computing devices limit the existing prior art solutions that provide some sort of data mobility. This despite the fact that memory prices has come down a fair bit in recent years and increasingly large flash memory devices (e.g., Universal Serial Bus “USB” drives) and flash memory cards (e.g. a Secure Digital “SD” card) are readily available in the market.

Thus one solution is to use an external flash memory device to carry a copy of the data. Another solution is use a flash memory card to increase the amount of available memory on a mobile device. But, despite the availability of large sized flash memory devices and cards, they are still not large enough to carry a copy of all data from one or multiple computers as may be desired in a given instance.

One other method for making data accessible while away from the data source is to backup the data to an online service provider and then downloading on demand the data files as needed. This option is rather expensive and may expose sensitive data to third parties (e.g., the online service providers) thus compromising privacy.

One prior art method is to use a mobile device. Over the past few years mobile devices have become very sophisticated; they increasingly have more computing power, have large on board memory, may have WiFi wireless local area network connectivity and may even have flash memory card compatible slots. Mobile devices have increasingly large internal memory and can carry lots of documents but this memory may not be enough to carry a complete copy of data from a computer or an entire network. One way to carry a larger amount of data than your storage capacity allows, is to compress the data files so that they may take less space for storage. Another method is to only carry the important/select files thus again taking less space than it would take if all files were saved on the mobile device.

Our invention overcomes these and other limitations of the prior art.

### SUMMARY

In one example is a data access method comprising: extracting metadata of any data files and folder hierarchy of a data source; creating a data map of the data files and folder hierarchy of the data source using the extracted metadata; saving to a mobile device the data map of the data files and folder hierarchy of the data source; and displaying to a user the data map of the data files and folder hierarchy of the data source.

In another example is a data access method comprising: coupling a mobile device to a data map viewer source; creating a unique email address at the data map viewer source; associating the unique email address with the data map viewer at the data map viewer source; downloading the data map viewer from the data map viewer source to the mobile device; coupling the mobile device to a data source containing a data map of any data files and folder hierarchy of the data source; registering the unique email address associated with the data map viewer at the data source; transferring the data map from the data source to the mobile device; extracting metadata of updates to the data file and folder hierarchy of the data source; emailing to the mobile device using the registered unique email address the extracted metadata of updates to the data file and folder hierarchy of the data source; and saving to the data map on the mobile device the extracted metadata of updates to the data file and folder hierarchy of the data source.

### BRIEF DESCRIPTION OF DRAWINGS

FIG. 1 is a block diagram of the creation and transfer of a data map according to one embodiment.

FIG. 2 is an exemplary process flow of the creation, transfer and use of a data map according to one embodiment.

FIG. 3 is an exemplary file explorer display window.

FIG. 4 is an exemplary process flow of the extraction of metadata for the creation of a data map according to one embodiment.

FIG. 5 is an exemplary table storing a data map according to one embodiment.

FIG. 6 is an exemplary data map stored in an XML file according to one embodiment.

FIG. 7 is an exemplary data map viewer display window displaying a data map according to one embodiment.

FIG. 8 is an exemplary process flow of downloading to a mobile device a data map viewer with an associated unique email address according to one embodiment;

FIG. 9 is an exemplary process flow of registering the unique email address of a data map viewer with a data map data source according to one embodiment;

FIG. 10 is an exemplary process flow of extracting metadata for updates to a data source according to one embodiment;

FIG. 11 is an exemplary process flow of sending the extracted metadata for updates to a data source to a mobile device using a registered unique email address of a data map viewer according to one embodiment.

### DETAILED DESCRIPTION OF THE INVENTION

Typically an operating system of a data source incorporates a file system to provide a means for a user to access the data files stored on the data source. The file system provides a method of storing and organizing the data files as well as access to the data files by a user. In some implementations the file system is responsible for organizing physical sectors of the underlying data storage device (e.g. a hard drive disk), and managing the data structure elements that these sectors represent (i.e., files and folders) by keeping track of which sectors belong to which files and which sectors are not in use (free space). File systems typically have directories which may contain files or sub-directories or both. The file system may also include intermediate data structure elements containing data about data files. This intermediate data or “data about data” is called metadata by those of skill in the art. Metadata may contain information such as file name, file path, file size, date created, date modified, author and permissions amongst other information. In the file systems the metadata is typically stored along with the actual data files.

Described herein are systems and methods of creating a portable data map using the metadata. The created data map represents the entire data set of a data source and can be carried on a mobile device without actually carrying the entire data set and thus requiring much less storage space. A user of the mobile device can navigate this data map and vim the file/folder hierarchy even when the mobile device is off line. Once a user has made a selection the actual file(s) can be downloaded to the mobile device.

One advantage is that a user can carry a data map of one or more data sources in a compact memory foot print. Navigating a data map, a user can view the files and folders as if the data is actually saved on the local storage of the mobile device. A user can see the file icons and other useful information like file name, file size, file type, date last modified, etc. The user can navigate through the data map's virtual files and folders in the same hierarchy as in the original data on the data source from where the data map was created. Alternatively the user can have a category based view, for example showing all photos, music, documents etc.

In one embodiment a data map viewer is provided that displays iconically the files that have been downloaded to the local memory of the mobile device, with e.g., a green check mark shown in the displayed file icon. In another embodiment the displayed file icon may be grayed out to represent a file that is not present locally on the mobile device.

By carrying this data imp on a mobile device and by navigating and selecting data files from the data map the user can have immediate access to the select data files. For example a sales person when visiting a customer may wish to make a presentation using an Apple Inc, iPhone and a projector. The data map for the office network is carried on the sales person's iPhone and by navigating the data map the file can be downloaded to their iPhone for the meeting.

Thus a user can effectively carry the data maps of one or more data sources in a rather compact mobile device without requiring too much storage space yet have virtual access to all such data represented by the data map. Using known security methods such as password protection, a user can restrict access to the data map.

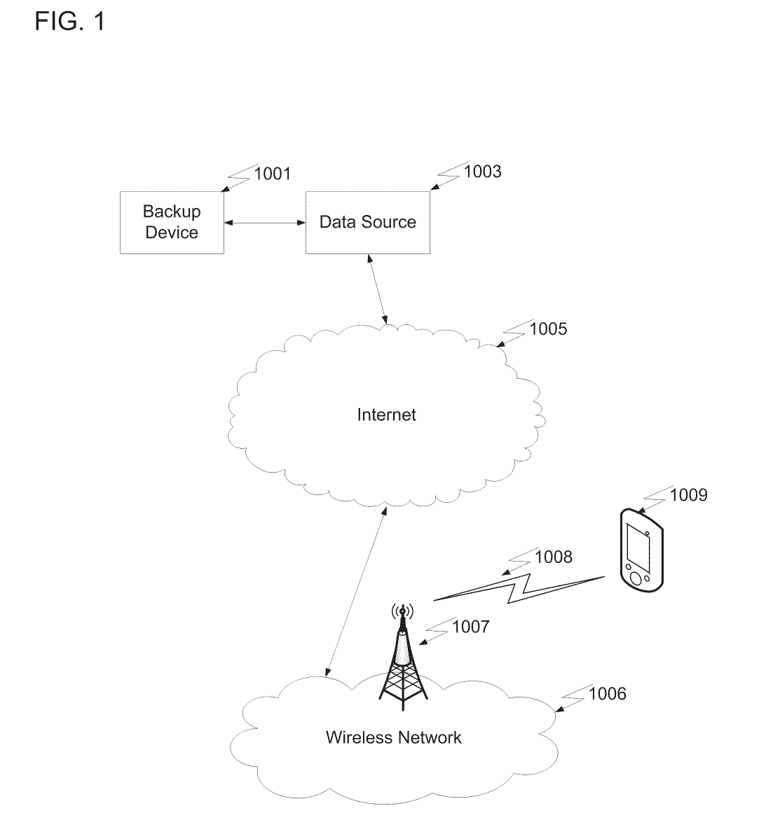

Referring now to FIG. 1 one embodiment can be seen. A backup device 1001 such as, for example as described in U.S. Pat. No. 7,8189,160 which is incorporated by reference in its entirety herein, is wired or wirelessly connected to a data source 1003. Data source 1003 is backed up to the backup device 1001 according to known techniques. Backup device 1001 also creates a data map of data source 1003 as described further herein. The data source 1003 is connected to a network such as the interact 1005 which is, in turn, connected to a wireless network 1006 such as a cellular data network. Wireless transmitter 1007 is part of the wireless network 1006 and transmits radio signals 1008 to a mobile device 1009. The data map created by backup device 1001 is communicated across network 1005 to wireless network 1006 to be stored on mobile device 1009.

In a preferred embodiment mobile device 1009 has a data map viewer installed on it for graphically displaying the stored data map. The data map stored on mobile device 1009 can be navigated by the user to select certain files, and those select files can be downloaded from the backup device 1001 to the mobile device 1009 via the network connection.

In one embodiment, the data map viewer includes a File Transfer Protocol (FTP) connection with the data source 1003 or the backup device 1001 for file transfer and data map synchronization as will be explained. In another embodiment the data map viewer installed on mobile device 1009 can open a private or a public port for communication across internet 1005 with data source 1003 or backup device 1001. The possible approaches are not limited to the exemplary embodiments described here, but in fact the intent is to include all such methods and mechanisms for data transfer known to ones skilled in the art.

In an alternative embodiment, backup device 1001 is a Network Attached Storage (NAS) device connected to a local area network (not shown) which is in turn connected to internet 1005. In this embodiment multiple data sources such as data source 1003 can be backed up by the NAS backup device 1001. Mobile device 1009 can have the data map for the entire backup device 1001 and thus can have access to all files stored on it.

In an embodiment where multiple data sources are backed up by backup device 1001, a separate data map is created for each data source. In this embodiment portable device 1009 stores select data maps each representing a distinct data source and the user can access select files stored on the backup device 1001.

In recent years, Smartphones have become very sophisticated with increasingly fast CPUs, large onboard memory and internet access, thus becoming the primary computing devices for a lot of people. Some users may have a substantial amount of data saved on such devices. In an exemplary embodiment a first person has a first iPhone with files stored on it while a second person may have a second iPhone with the data map of the first iPhone stored on it. Using the data map of the first iPhone, the user of the second iPhone can access the files stored on the first iPhone.

The data source as referred to in this application especially in the preferred embodiment is a personal computer with a set of electronic data files. The data source is not limited to the examples cited here and could be a home personal computer (PC), corporate PC, a Server, a laptop, a settop box, an Apple Inc. Macintosh computer, a cellular phone, a Smartphone, a personal digital assistant (PDA), a personal video recorder (PVR), an iPod tablet sold by Apple Inc., an iPad music player sold by Apple Inc., an e-book reader such as the Kindle sold by Amazon, etc., running any number of different operating systems as diverse as the Microsoft Windows family, the Apple Inc. MacOS family, any variation of Linux or Unix, PalmOS, or such operating systems used for such devices available in the market today or the ones that will become available as a result of the advancements made in such industries.

The term backup device as referred to in herein and especially in the preferred embodiment is an electronic device that is capable of backing up the data from a data source. The term mobile device as referred to herein can be a phone, a smart phone, a PDA, an iPod Touch, an iPhone, iPad, a RIM Blackberry device as sold by Research in Motion, an e-reader such as the Kindle sold by Amazon, The Reader sold by Sony, a Slate tablet device as sold by Hewlett Packard, a USB flash drive, a flash memory card such as SD card, or any other such device that is compact, affords mobility, where data can be stored and where a network connection is available either natively or by connection to another networked device.

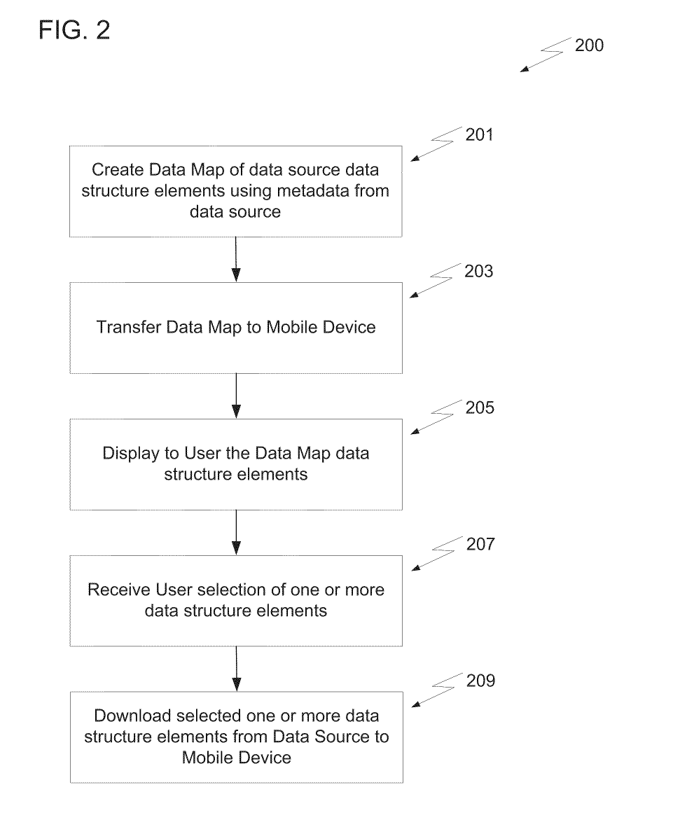

Referring now to FIG. 2 an exemplary process flow can be seen. In step 201, a data map of the data structure elements (files and folders) of a data source is created using metadata from the data source. In step 203, the created data map is transferred to a mobile device. In step 205, the created data map now residing on the mobile device is displayed to the user typically via a data map viewer. Using the displayed data map, the user can navigate the data structure elements (files and folders). In step 207, a user selection of one or more data structure elements from the displayed data map is received by the mobile device. In step 209, the user selected one or more data structure elements are downloaded from the data source (or a backup device) to the mobile device. Each of these steps and operations is explained further herein.

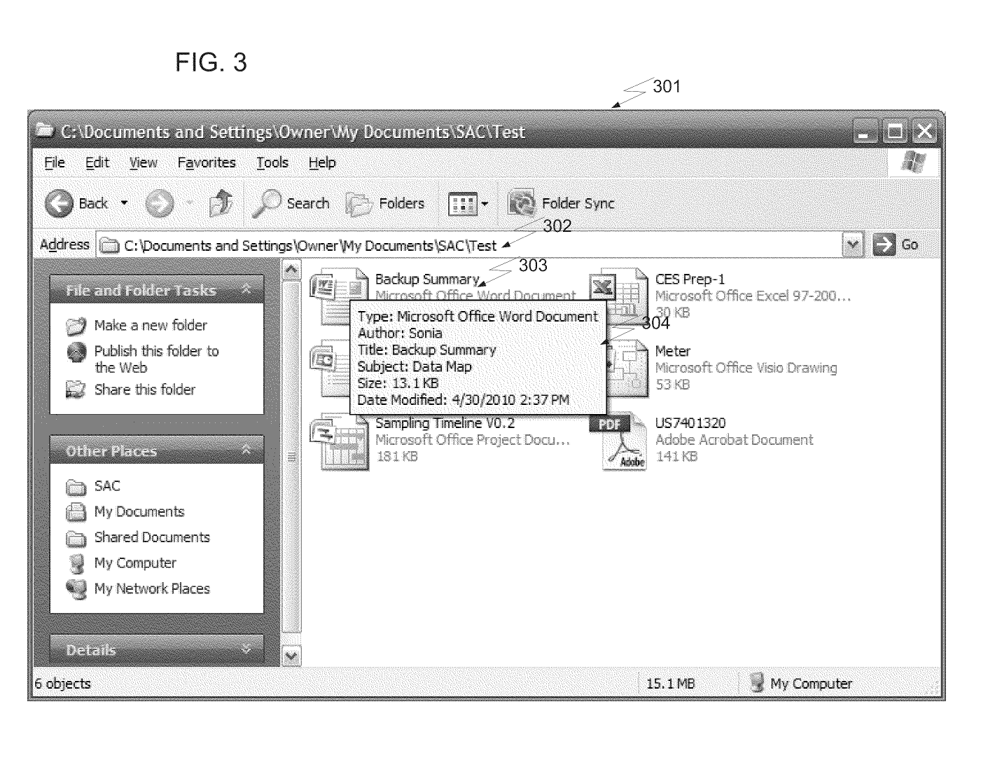

Referring now to FIG. 3 an exemplary Microsoft Windows file explorer window 301 can be seen. As is known in the art, Windows File Explorer is a file manager application included with releases of the Microsoft Windows operating system from Windows 95 onwards that provides a graphical user interface for accessing files. It is also the component of the operating system that presents the user interface on a display and enables the user to navigate attached storage devices such as a hard drive, optical disc, etc.

In the Windows File Explorer example shown in FIG. 3, the file directory location of the open folder is shown in an address bar 302. As also shown, within this open folder is a data file entitled “Backup Summary” 303 that is displayed as a graphical icon.

When using Windows File Explorer in the Microsoft Windows operating system, if a user hovers a mouse driven cursor over such a displayed file icon a text box is displayed showing available metadata attributes of the file such as text box 304 which, as shown, displays the following metadata attributes about the file Backup Summary 303:

Type: “Microsoft Office Word Document”

Author: “Sonia”

Title: “Backup Summary”

Subject: “Data Map”

Size: “13.1 KB”

Date Modified: “4/30/2010 2:37 PM”

A data map is a representation of the data stored on a data source without the actual data. The relationship between a data source and its data map may be more readily understood by comparing it to the relationship between a library and its catalogue. A library catalogue is a register of all items found in a library. Some libraries may still have a physical card catalogue on site but essentially most libraries have effectively replaced these with online catalogues. Thus a catalogue represents all items contained in the library and provides a summary of information that may help a user find the said item. Such information may include the title, name of author, year of publication, publisher, perhaps also a brief summary.

Thus like the library catalogue, the footprint of a data map is much smaller than the data it represents; therefore a data map can be easily saved to a mobile device with a limited memory size. The method disclosed herein allows a user to effectively carry a data map representing several Gigabytes or even several Terabytes of data in a much smaller memory storage device yet have ready access to the entire data set it represents.

In one embodiment the user may download/a software application to a data source for creating a data map of the data structure elements (files and folders) located on the data source using metadata attributes of the files on the Data Source. This software application may be an independent application or this feature may be part of another software application for example a data backup application bundled with a data backup device. The software application may also create data maps of other data sources attached to the network. The software application may save the data map in a particular format for use with a particular type of mobile device and transfer the data map(s) to the respective mobile device(s). Preferably this software application also sends the data map to the mobile device and keeps it synchronized.

Various known mechanisms can be used by such an application to create a data map. For example, within the Windows operating system environment, the CFileFind class performs local file searches and can be used for the extraction of metadata attributes of files on a data source. It is to be understood that although the embodiments described herein use Microsoft Windows operating system as an example, the intent is to cover all such operating systems used for Data Sources. As is known in the art, CFileFind constructs a CFileFind object. It includes member functions that begin a search, locate a file, and return the title, name, or path of the file. The members of the CFileFind class are listed in Table 1, while the operations for the class are listed in Table 2.

TABLE 1
Members of CFileFind class

| Attribute | Description |
|---|---|
| GetCreationTime | Gets the time the file was created |
| GetFileName | Gets the name, including the extension, of the found |
| | file |
| GetFilePath | Gets the whole path of the found file |
| GetFileTitle | Gets the title of the found file, but does not include |
| | the extension |
| GetLastAccessTime | Gets the time that the file was last accessed. |
| GetLastWriteTime | Gets the time the file was last changed and saved |
| GetLength | Gets the length of the found file, in bytes |
| GetRoot | Gets the root directory of the found file |
| IsAchieved | Determines if the found file is archived |
| IsCompressed | Determines if the found file is compressed. |
| IsDirectory | Determines if the found file is a directory. |
| IsDots | Determines if the name of the found file has the |
| | name “.” or “..”, indicating that is actually a |
| | directory |
| IsHidden | Determines if the found file is hidden |
| IsNormal | Determines if the found file is normal (in other |
| | words, has no other attributes) |
| IsReadOnly | Determines if the found file is read-only |
| IsSystem | Determines if the found file is a system file |
| IsTemporary | Determines if the found file is temporary |
| MatchesMask | Indicates the desired file attributes of the file to be |
| | found |

TABLE 2
Operations for CFileFind class

| Operation | Description |
|---|---|
| Close | Closes the search request |
| CloseContext | Closes the file specified by the current search handle |
| FindFile | Searches a directory for a specified file name |
| FindNextFile | Continues a file search from a previous call to FindFile |

For example, the following code will enumerate all the files in the current directory, printing the name of each file, etc.:

CFileFind finder;

BOOL bWorking = finder.FindFile(“*.*”);
while (bWorking)

{

bWorking = finder.FindNextFile( );
cout << (LPCTSTR) finder.GetFileName( ) << endl;

}

CFileFind finder;
int nFindCount = 0 ;
BOOL bWorking = finder.FindFile( archPath );
while ( bWorking )
{

bWorking = finder.FindNextFile( );
if ( !finder.IsDots( ) && !finder.IsDirectory( ) )
{

```
  WaitForSingleObject( pBFDlg-
  >m_hEventFindLoaded, 120000 ) ;
  pBFDlg−>m_arstrFindFile.Add(
  finder.GetFilePath( ) ) ....
```

As an alternative, the method can also use the system registry to get the MIME type of a file, by using the registry key HKEY_CLASSES_ROOT\MIME\Database\Content Type\.

Using IApplicationAssociationRegistration:: QueryCurrentDefault( ) API can provide the following:
Unicode string that contains the file extension or protocol, such as .mp3 or http;
Enumeration values that specify the type of association, such as extension or MIME type;
Enumeration values that specifies the level of association, such as per-user or machine (user name);
Pointer to the ProgID that identifies the current default association.

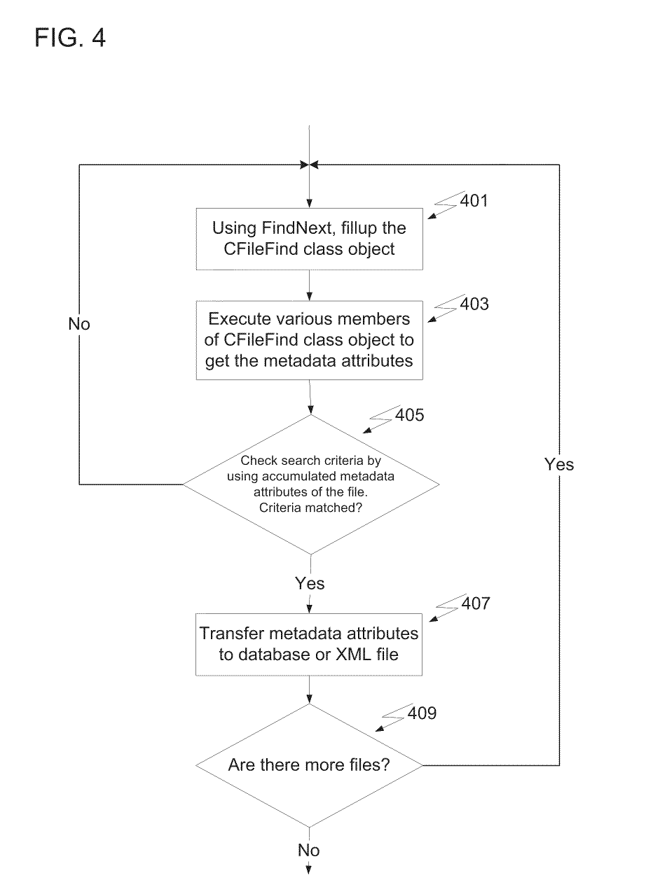

Referring now to FIG. 4, a flow-chart representation of a method for the extraction of metadata attributes from files using the CFindFile class in Microsoft Windows operating systems can be seen. In step 401 FindNext is used to fill the CFindFile class object. In step 403 various members of the CFindFile class are executed to extract metadata attributes of the file. The various members of the CFindFile class are listed in Table 1. In step 405 search criteria is checked by using accumulated metadata attributes of the file (e.g., using the MatchesMask command). If the desired search criteria are not yet achieved, FindNext is again used to fill the CFileFind class by returning to step 401. Alternatively, if the desired search criteria are achieved then in step 407 the metadata attributes are transferred to a database or XML file. If there are more files on the data source as determined in step 409 then the process returns to step 401 to once again use FindNext to fill the CFileFind class and continue the process. Alternatively, if there are no more files then the process ends. Other operating systems, for example MacOS, provide similar functions that can be used by applications running on these operating systems for the extraction of metadata attributes of files in those systems.

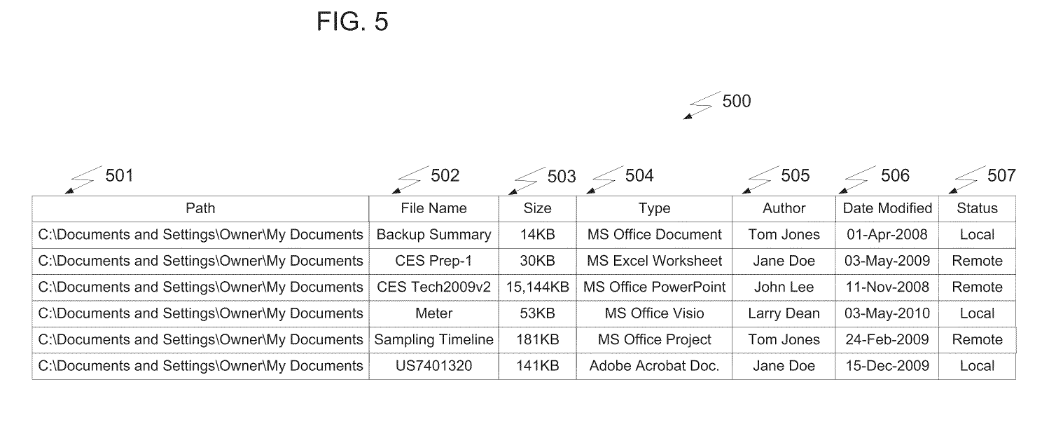

Referring now to FIG. 5 an exemplary table 500 for storing the Data Map can be seen. In one embodiment, the following metadata attributes may be extracted from the metadata of a data source running an operating system Microsoft Windows:
501 Path: the location on the original data source where the data files are stored.
502 File Name: the name of the data file.
503 File Size: the size of the data file expressed in bytes, kilobytes, megabytes or other units.
504 File Type: the description of the file type, what application it may pertain to.
505 Author: the name of the person who may have authored the data file.
506 Date Modified: the date when the last changes were made to the data file,
507 Status: Local or Remote: an indicator flag to display iconically to the user if the file has already been downloaded to the mobile device (local) or is it on the data source (remote).

The above list is exemplary and is based on the Microsoft Windows operating system. Other operating systems such as MacOS, Linux, Ubuntu, etc., may have a similar or a different set of metadata attributes that can be extracted from the metadata available in those operating systems. Thus approach described herein can essentially cater to many different operating systems and is not limited by the examples used here.

In the preferred embodiment, the status 507 of the file, i.e., is it locally available or remote is also stored in the database. For example if the file has already been downloaded to the mobile device its status is local, else its status is remote.

In one embodiment, the downloaded files may be stored in the database along with the data map.

In one embodiment other information about the files may also preferably be stored in the database along with the data map. This information may include but not be limited to thumbnails of the files. A thumbnail may be created using the first frame of a video file, the view of the first slide of a PowerPoint presentation file, the view of the first page of a Word document file, etc.

In one embodiment the data map from each data source is saved to a separate table in the data base. In one embodiment the data maps from different data sources are saved to a singular table with a field in each row labeling and identifying the data source that the data map represents.

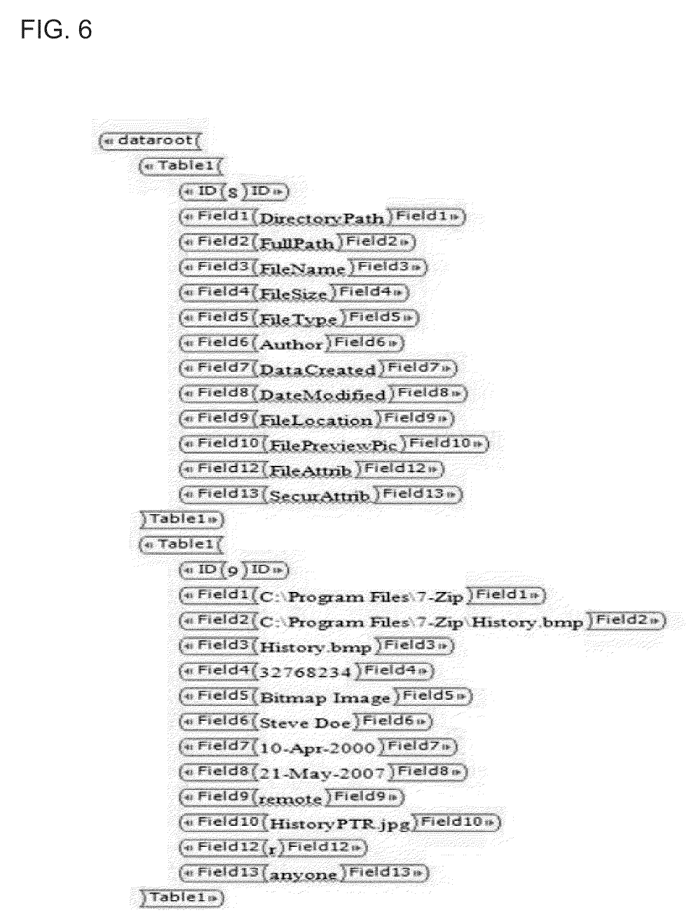

In one embodiment the data map may be stored in an XML schema. An example of such an XML code snippet is shown in FIG. 6.

In another embodiment an XML parser may be integrated with the data map viewer to parse the data map stored in an XML file.

In an exemplary embodiment the data map may be downloaded to a mobile device once the mobile device is connected to the data source where the data map was created. In another embodiment the data map may be pushed to the mobile device or the mobile device may pull the data map from the Data Source. The data map transfer may take place on a LAN, a WAN, the internet, a WiFi network or a cellular Data Network, for example.

In one embodiment the data backup device when backing up the data source also creates the data map representing the Data Source. This data map can then be transferred to the mobile device using any of the exemplary mechanisms described herein.

Such data transfers are not limited to the exemplary embodiments described herein, but in fact the intent is to include all such methods and mechanisms known for data transfer to the ones skilled in the art.

In one embodiment the data map is viewable in a data map viewer application designed for the mobile device, preferably allowing a user to navigate the data map, search using different criteria, display the results of the search, and allowing the user to download select data files with a single action. These examples are used for illustrative purposes as other operations can likewise be performed.

In one embodiment, the data map viewer displays the data map using the respective icons that are associated with the data file type, e.g., Microsoft Office Word files are displayed with the default icon that is associated with Microsoft Office Word files in the Microsoft Windows operating system. As such, the icons may vary from one version of the software to another, e.g., in Microsoft Windows the icons for Microsoft Office 2003 version are different from those for Microsoft Office 2007 version.

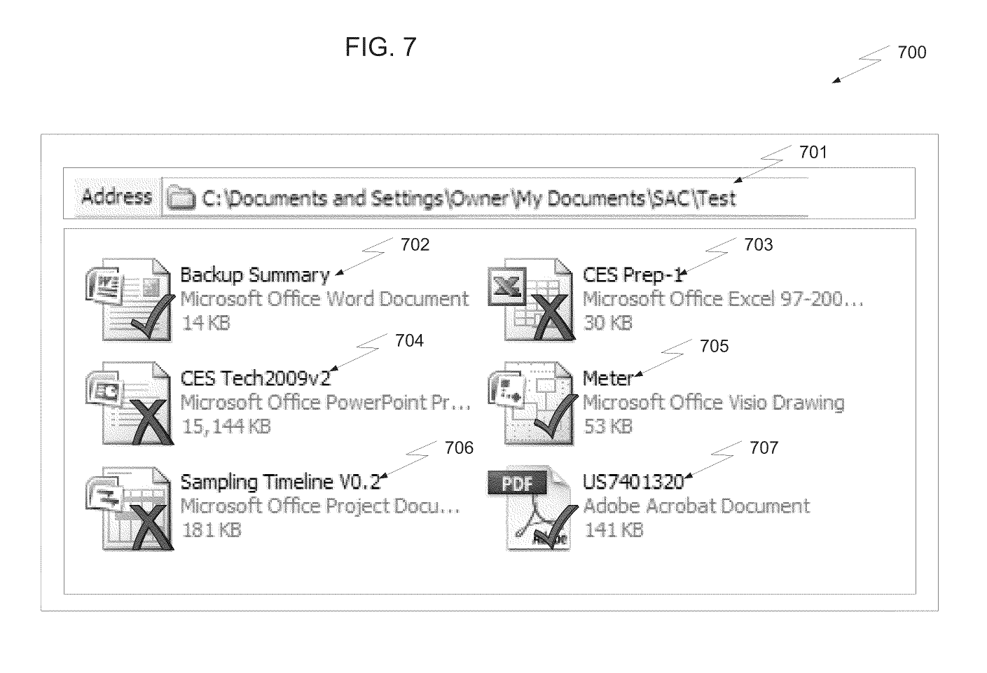

Referring now to FIG. 7 an exemplary display window is shown depicting a data map viewer 700 displaying a data map based on the metadata from a data source. The address bar 701 shows the path where the folder is saved on the original data source. In the data map the individual files are shown graphically with the file type icon, retaining the same icons that are used in the original operating system of the data source from where the data map was created. A file icon 702 is shown representing a “Microsoft Office Word Document” file with a name “Backup Summary” and a size of “14 KB.” Further, a check mark is shown on the displayed file icon 702 indicating that the file is already downloaded to the local memory of the device where the data map is being viewed.

Another file icon 703 is shown representing a “Microsoft Office Excel 97-2000” worksheet with a name “CES Prep-1” and a size of “30 KB.” Further, a cross mark is shown on the displayed file icon 703 indicating that the file is not currently present on the local memory of the mobile device where the data map is being viewed.

Another file icon 704 is shown representing a “Microsoft Office PowerPoint Presentation” file with name “CES Tech2009v2” and a size of “15,144 KB.” Further, a cross mark is shown on the displayed file icon 704 indicating that the file is not currently present on the local memory of the mobile device where the data map is being viewed.

Another file icon 705 is shown representing a “Microsoft Office Visio Drawing” file with a name “Meter” and a size of “53 KB.” Further, a check mark is shown on the displayed file icon 705 indicating that the file is already downloaded to the local memory of the mobile device where the data map is being viewed.

Another file icon 706 is shown representing a “Microsoft Office Project” file with a name “Sampling Timeline V0.2” and a size of “181 KB.” Further, a cross mark is shown on the displayed file icon 706 indicating that the file is not currently present on the local memory of the mobile device where the data map is being viewed.

Another file icon 707 is shown representing an “Adobe Acrobat Document” file with a name “U.S. Pat. No. 7,401,320” and a size of “141 KB.” Further, a the check mark is shown on the displayed file icon 707 indicating that the file is already downloaded to the local memory of the device where the data map is being viewed.

In one embodiment, the data map viewer displays the photos, videos and other audio-video files as thumbnails for easier navigation and identification. Thumbnails can be generated using the first frame of a video, the first page of a PDF document, the first slide of a PowerPoint Presentation, etc., as is known in the art.

In an exemplary embodiment and as shown in FIG. 7, the data map visually indicates if the data file is not present locally by, for example, indicating such with a cross mark. Once the file is downloaded to the mobile device where the data map resides, the visual indicator is toggled, for example, from a cross mark to a check mark. Similarly if the file has been downloaded and is present locally on the mobile device but then a user deletes the local version of the data file, will cause the visual indicator to toggle from, for example, a check mark to a cross mark.

In one embodiment the data map viewer may have an FTP (File Transfer Protocol) connection with the data source or the Backup Device for data map and file transfer.

In another embodiment the data map viewer on the mobile device may open a private or a public port for communication with the data source or the Backup Device.

In one embodiment the data map viewer is installed on the mobile device when the user connects the mobile device to the data source where the data map was originally created. In one embodiment the data map is pushed to the mobile device from the Data Source. Alternatively the data map can be pulled by the mobile device from the Data Source.

In another embodiment the user can download the data map viewer from an online application store, e.g., the Apple Inc. App Store.

In one embodiment, the user can download a selected file from the data source to the mobile device preferably by taking a single action, for example, by selecting the file by clicking on a displayed icon representing the file. Preferably some embodiments allow the user to download a needed file by navigating a data map to select a file(s) and preferably clicking on it which triggers communication with the data source or backup device containing the selected file(s) to cause the downloading operation to occur. As an example if the user is e-mailing a message and wants to attach a file from the data map on the mobile device, the user experience will be exactly the same as if the file is stored locally on the mobile device. The user selects the file by navigating the files and folders in the data map and selects the file(s) needed. Once the user clicks the send/save button the select file is downloaded from the remote backup and attached to the e-mail message.

As such, in a preferred embodiment, using the data map viewer application the user can:

Download selected file(s)

Download a selection of folders and directories

Download based on a category; e.g. all Microsoft Office Word Document files

Download based on date range

Download based on author

Any combination of the above and other criteria

In order to provide secure access to the data nap, known methods may be employed by the data map viewer, for example a user may be required to enter a password. In one embodiment the data map itself may be encrypted for added security.

In one embodiment the data map may be viewed using alternate viewers for example using the Windows File Explorer.

In another embodiment the data map can be viewed and navigated using whatever file system explorer is installed on the mobile device. The data map is represented with graphical icons pertinent to the mobile device and the user can navigate the data map as if navigating the file/folder structure/hierarchy of the original data source.

In another embodiment a database and a database engine may be integrated with the data map viewer installed on the mobile device.

One embodiment offers a method for keeping the data map synchronized with the data source. This ensures that the data map does not become stale in the wake of changing files on the data source. Thus keeping the data map on the mobile device synchronized with the files on the data source or backup device provides a significant advantage.

In a preferred embodiment, the data map is kept synchronized with the original data by either sending periodic updates to the mobile device or immediate updates when changes are made to the original files on the data source(s). In another embodiment the data map updates may be pulled by the data map viewer installed on the mobile device.

In one embodiment, the data map on the mobile device is kept updated by sending the changes via a file/package download to the data map viewer on the mobile device. Preferably the data map viewer periodically checks and downloads the requisite updates to the data map from the data source where preferably a software application may keep a track of the changes to the files saved on the data source or the backup device. Any changes to the files are translated to a corresponding change in the data map, and a file or package containing these changes is pushed to the mobile device where the data map viewer can update the data map. In one embodiment the data map viewer can periodically pull the file or package containing the changes from the data source.

In one embodiment the raw updated metadata is downloaded to the mobile device and it is converted to the respective changes in the data map.

In one embodiment when a downloaded file is deleted on the mobile device, it deletes the file but does not delete metadata attributes of this file in the data map. Thus using the data map a user can download the same file again if needed.

In another embodiment when a downloaded file is deleted on the mobile device it deletes the file and also deletes the associated metadata attributes in the data map.

in yet another embodiment when a downloaded file is deleted on the mobile device it deletes the file and also deletes the associated metadata attributes in the data map. Upon the next connection of the mobile device to the data source it then also deletes the source file on the data source thus keeping the actual files on the data source synchronized with the data map on the mobile device.

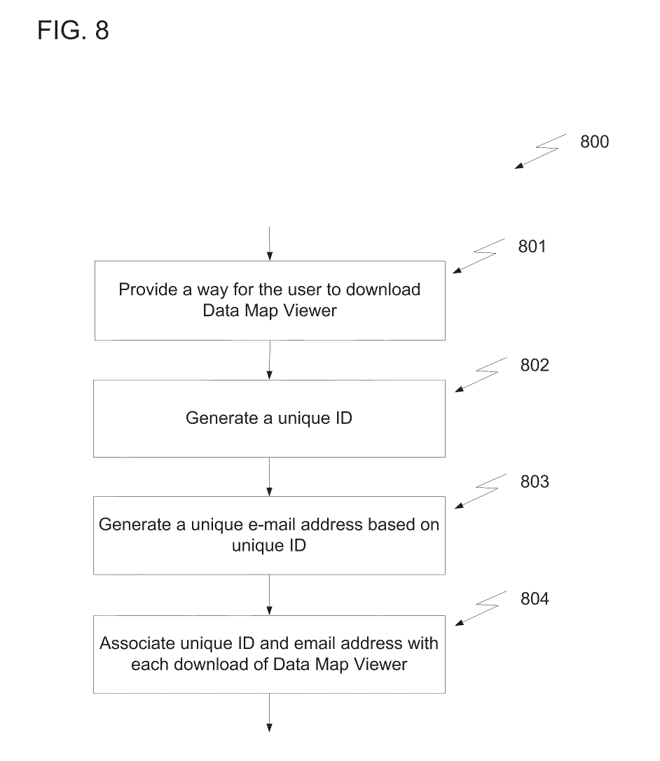

In still another embodiment, updates to a data map are transferred to a mobile device based on associating an email address with a data map viewer that is installed on the mobile device. The updates to the data map can then be pushed to the mobile device by including them as an attachment to an email sent to the associated email address. Upon receiving the email, the data map viewer can then extract the attachment containing the updates, update the data map accordingly and display the updated data map to the user on the mobile device. This will now be further explained with reference to FIGS. 8-11.

Referring now to FIG. 8 is a flowchart representation of an exemplary method 800 for downloading a data map viewer to a mobile device and generation and association of a unique identification (ID) and unique email address for the data map viewer being downloaded. In step 801 a user of a mobile device couples the mobile device to a source that can download a data map viewer, for example, a website where a particular data map viewer for a particular mobile device can be selected and downloaded. In step 802 a unique ID is generated and in step 803 a unique email address is generated based on the generated unique ID. In step 804 the data map viewer to be downloaded is associated with the generated unique ID and generated unique email address after which the data map viewer is downloaded to the mobile device.

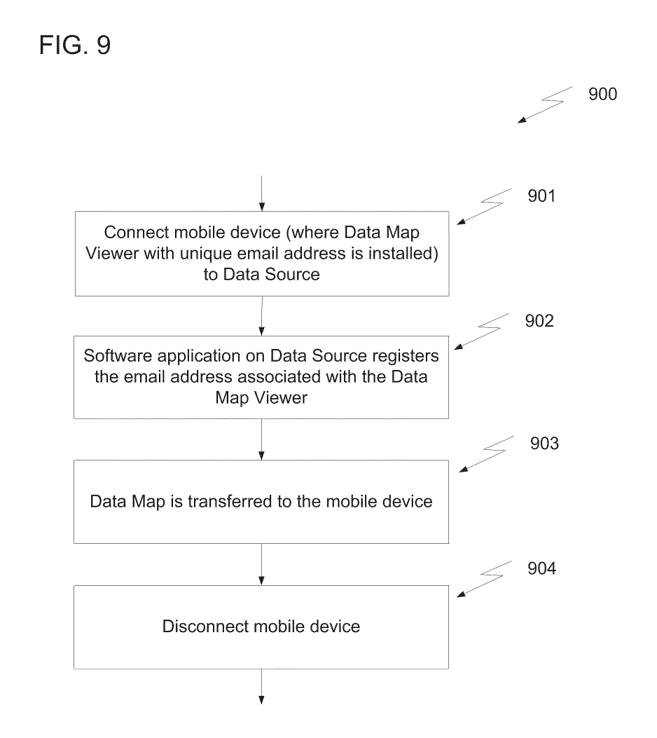

Referring now to FIG. 9 is a flow-chart representation of an exemplary method 900 for registering the data map viewer with associated unique email address with a data source and transferring a data map to the mobile device. In step 901 the mobile device containing the downloaded data map viewer with associated unique email address is connected to the data source containing the data map. In step 902 the data source registers the unique email address associated with the data map viewer. In step 903 the data map is transferred from the data source to the mobile device and in step 904 the mobile device is disconnected from the data source.

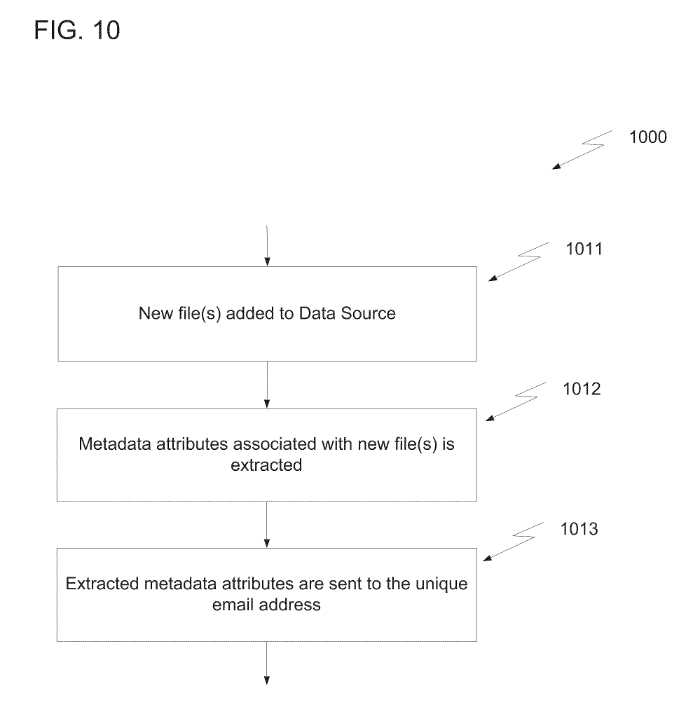

Referring now to FIG. 10 is a flow-chart representation of an exemplary method 1000 of sending data map updates to the mobile device via. In step 1011 one or more new file(s) are added to the data source. In step 1012 metadata attributes of the new file(s) are extracted using techniques such as those described above. In step 1013 the extracted metadata attributes are sent in an attachment to an email sent to the email address associated with the data map viewer registered by the data source in step 1012 (FIG. 9).

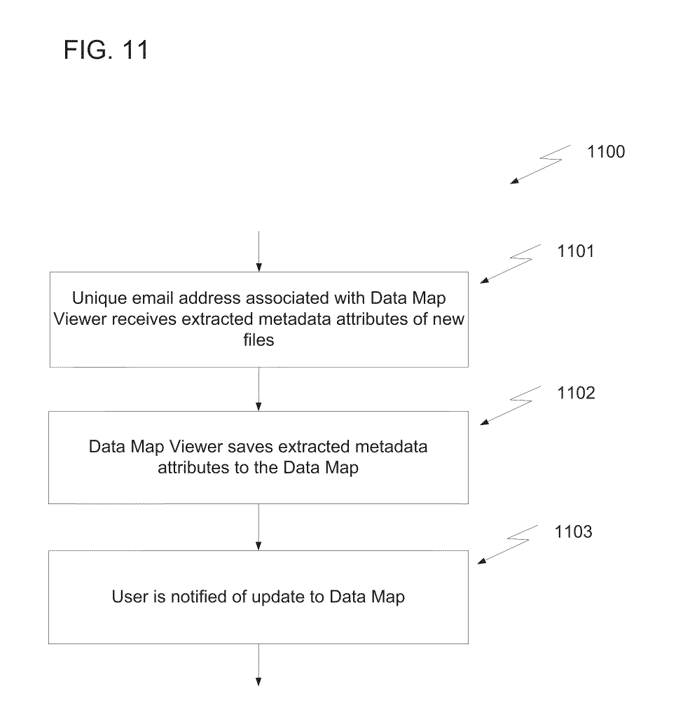

Referring now to FIG. 11 a flow-chart representation of an exemplary method 1100 of the data map viewer receiving the data map update by email. In step 1101 the mobile device receives the email sent to the unique e-mail address associated with the data map viewer which email has an attachment containing the extracted metadata attributes for the new file(s) which were added to the data source. In step 1102, the data map viewer saves the extracted metadata attributes from the email attachment to the data map on the mobile device. For example, if the data map is saved in a database on the mobile device then the database is updated with the metadata attributes received by email. In step 1103, the user is notified of the update to the data map.

The examples noted here are only for illustrative purposes and there may be further implementation embodiments possible with a different set of components. While several embodiments are described, there is no intent to limit the disclosure to the embodiment or embodiments disclosed herein. On the contrary, the intent is to cover all alternatives, modifications, and equivalents obvious to the ones familiar with the art.

All aspects described here are illustrative and not restrictive and may be embodied in other forms without departing from their spirit and essential characteristics.

It is to be understood that the exact sequences of the various operations described herein may be altered based on design choice so long as the underlying method and functionality is not altered in a way that would create an incorrect result or eliminate a needed dependency.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A data access method comprising:
extracting metadata of any data files and folder hierarchy of a data source;
creating a data map of the data files and folder hierarchy of the data source using the extracted metadata;
saving to a mobile device the data map of the data files and folder hierarchy of the data source; and
displaying to a user the data map of the data files and folder hierarchy of the data source.

2. The method of claim 1 wherein the step of extracting metadata of any data files and folder hierarchy of a data source is performed by a backup device coupled to the data source.

3. The method of claim 1 wherein the step of extracting metadata of any data files and folder hierarchy of a data source is performed by a Network Attached Storage (NAS) device in communication with the data source.

4. The method of claim 1 wherein the step of extracting metadata of any data files and folder hierarchy of a data source is performed by issuing operating system commands to the data source.

5. The method of claim 1 wherein the step of creating a data map of the data files and folder hierarchy of the data source using the extracted metadata further comprises saving the data map in the form of a database.

6. The method of claim 1 wherein the step of creating a data map of the data files and folder hierarchy of the data source using the extracted metadata further comprises saving the data map in the form of an XML file.

7. The method of claim 1 wherein the step of saving to a mobile device the data map of the data files and folder hierarchy of the data source comprises transferring the data map from the data source to the mobile device across a network.

8. The method of claim 1 wherein the step of displaying to a user the data map of the data files and folder hierarchy of the data source further comprises displaying the data map on the mobile device.

9. The method of claim 1 wherein the step of displaying to a user the data map of the data files and folder hierarchy of the data source further comprises displaying the data map on a display coupled to the mobile device.

10. The method of claim 1 wherein the step of displaying to a user the data map of the data files and folder hierarchy of the data source is performed by a data map viewer.

11. The method of claim 1 wherein the step of displaying to a user the data map of the data files and folder hierarchy of the data source further comprises displaying an indication that one of the data files has not been downloaded to the mobile device.

12. The method of claim 1 wherein the step of displaying to a user the data map of the data files and folder hierarchy of the data source further comprises displaying an indication that one of the data files has been downloaded to the mobile device.

13. The method of claim 1 further comprising:
receiving at the mobile device an update to the data map of the data files and folder hierarchy of the data source the update reflecting any changes to the data files and folder hierarchy of the data source.

14. The method of claim 1 further comprising:
receiving a user selection of one of the data files after the step of displaying to a user the data map of the data files and folder hierarchy of the data source;
transferring the user selected data file from the data source to the mobile device.

15. A data access method comprising:
coupling a mobile device to a data map viewer source;
creating a unique email address at the data map viewer source;
associating the unique email address with the data map viewer at the data map viewer source;
downloading the data map viewer from the data map viewer source to the mobile device;
coupling the mobile device to a data source containing a data map of any data files and folder hierarchy of the data source;
registering the unique email address associated with the data map viewer at the data source;
transferring the data map from the data source to the mobile device;
extracting metadata of updates to the data file and folder hierarchy of the data source;
emailing to the mobile device using the registered unique email address the extracted metadata of updates to the data file and folder hierarchy of the data source; and
saving to the data map on the mobile device the extracted metadata of updates to the data file and folder hierarchy of the data source.

16. The method of claim 15 further comprising displaying to the user the data map of any data files and folder hierarchy of the data source before the step of emailing to the mobile device using the registered unique email address the extracted metadata of updates to the data file and folder hierarchy of the data source.

17. The method of claim 15 further comprising displaying to the user the data map of any data files and folder hierarchy of the data source including updates to the data the and folder hierarchy of the data source after the step of saving to the data map on the mobile device the extracted metadata of updates to the data file and folder hierarchy of the data source.
